(19) United States
(12) Patent Application Publication
(10) Pub. No.: US 2010/0097300 A1
(43) Pub. Date: Apr. 22, 2010

(54) Plasma display panel and method of manufacturing the same

(76) Inventor: Sang-Hoon Yim, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/588,436

(22) Filed: Oct. 15, 2009

(30) Foreign Application Priority Data
Oct. 17, 2008 (KR) 10-2008-0101943

(51) Int. Cl. G09G 3/28; H01J 9/20

(52) U.S. Cl. 345/60; 445/24

(57) ABSTRACT

A plasma display panel includes an upper substrate and a lower substrate disposed to be opposite to each other, a plurality of address electrodes extending along a first direction on the lower substrate, a plurality of electrodes extending along a second direction on the upper substrate, the second direction intersecting the first direction, a plurality of light emitting cells partitioned by barrier ribs between the upper substrate and the lower substrate, the light emitting cells including first light emitting cells aligned in a first row along the second direction and second light emitting cells aligned in a second row along the second direction, the first row being offset along the first direction with respect to the second row, and phosphor layers in the light emitting cells, all the first light emitting cells in the first row having phosphor layers of a same color.

### BACKGROUND

1. Field

Example embodiments relate to a plasma display panel and a method of manufacturing the same. More particularly, example embodiments relate to a plasma display panel capable of reducing power consumption and improving discharge efficiency, and a method of manufacturing the same.

2. Description of the Related Art

A plasma display panel is a flat panel display device displaying characters or images by allowing phosphors to emit light by plasma generated at the time of gas discharge. Such a plasma display panel may have higher brightness, better light emitting efficiency, and wider viewing angle, e.g., as compared to a liquid crystal display device or a field emission display device, so it has been spotlighted as a display device to replace, e.g., a cathode ray tube (CRT) display device.

A conventional plasma display panel may include an upper substrate and a lower substrate disposed to be opposed to each other, barrier ribs disposed between the upper substrate and the lower substrate and defining discharge cells, and sustain electrodes and address electrodes disposed on the upper substrate and the lower substrate, respectively, for selecting and discharging discharge cells. A pixel may include red, green, and blue sub-pixels, i.e., discharge cells, wherein the sub-pixels may include red, green, and blue phosphor layers.

The plasma display panel may be driven through the steps: an initialization step where charges of a discharge cell are evenly disposed, an address step where wall charges are accumulated on a discharge cell to be driven, and a sustain discharge step where discharge is maintained for display.

However, since the conventional plasma display panel has a relatively large distance between the sustain electrodes on the upper substrate and the address electrodes on the lower substrate, discharge delay may occur. While the discharge delay may be minimized when high voltage having relatively great difference is applied between the sustain electrodes and the address electrodes, application of the high voltage may increase power consumption in the plasma display panel, thereby decreasing driving stability of the plasma display panel.

### SUMMARY

Embodiments are therefore directed to a plasma display panel and a method of manufacturing the same, which substantially overcome one or more of the problems due to the limitations and disadvantages of the related art.

It is therefore a feature of an embodiment to provide a plasma display panel structure capable of reducing power consumption and inducing stable discharge.

It is therefore another feature of an embodiment to provide a method of manufacturing a plasma display panel capable of reducing power consumption and inducing stable discharge.

At least one of the above and other features and advantages may be realized by providing a plasma display panel, including an upper substrate and a lower substrate disposed to be opposite to each other, a plurality of address electrodes formed on the lower substrate, a plurality of electrodes formed on the upper substrate in the direction intersecting with the plurality of address electrodes, a plurality of light emitting cells partitioned by barrier ribs between the upper substrate and lower the substrate, the light emitting cells including first light emitting cells aligned in a first row along the second direction and second light emitting cells aligned in a second row along the second direction, the first row being offset along the first direction with respect to the second row, and phosphor layers in the light emitting cells, all the first light emitting cells in the first row having phosphor layers of a same color.

Light emitting cells with phosphor layers having the same color may be disposed in a same column along the first direction. Three light emitting cells including respective red, green, and blue phosphor layers may define a pixel, one of the three light emitting cells being a first light emitting cell in the first row and the remaining two light emitting cells being second light emitting cells in the second row. The second light emitting cells in the second row may have phosphor layers of two colors arranged in an alternating pattern, the two colors of the phosphor layers in the second row being different than the phosphor layer color in the first row. The first light emitting cells in the first row may be spaced apart from each other by a constant predetermined interval, the first and second rows overlapping each other along the first direction.

The plurality of address electrodes may include at least one extension part and at least one expansion part, the expansion part being wider than the extension part along the second direction. The expansion part may be circular or polygonal, the extension part being centered with respect to the expansion part. The address electrodes may be arranged to correspond to the light emitting cells, the address electrodes including first address electrodes offset along the first direction with respect to second address electrodes, the expansion parts of the first and second address electrodes being in different rows along the second direction. The expansion part may be positioned inside each of the plurality of light emitting cells. The barrier rib may be between adjacent expansion parts. The plurality of electrodes may be parallel with each and crossing the plurality of light emitting cells in a direction intersecting with the plurality of address electrodes. The plurality of electrodes may be indented to correspond to positions of the plurality of light emitting cells.

At least one of the above and other features and advantages may be realized by providing a method of manufacturing a plasma display panel, including forming an upper substrate and a lower substrate disposed to be opposite to each other, forming a plurality of address electrodes extending along a first direction on the lower substrate, forming a plurality of electrodes extending along a second direction on the upper substrate, the second direction intersecting the first direction, forming a plurality of light emitting cells partitioned by barrier ribs between the upper substrate and the lower substrate, the light emitting cells including first light emitting cells aligned in a first row along the second direction and second light emitting cells aligned in a second row along the second direction, the first row being offset along the first direction with respect to the second row, and forming phosphor layers in the light emitting cells, all the first light emitting cells in the first row having phosphor layers of a same color.

The may further include forming dielectric substances throughout the lower substrate including the plurality of address electrodes, forming a plurality of pixels by coating the plurality of light emitting cells with red phosphors, green phosphors, and blue phosphors, the first light emitting cell in each of the plurality of pixels being disposed in the first row and the other two light emitting cells in each pixel being disposed in the second row. Each of the plurality of address electrodes may include at least one extension part and at least one expansion part, the expansion part being wider than the extension part along the second direction. The expansion part may be circular or polygonal, the extension part being centered with respect to the expansion part. The expansion part may be positioned inside each of the plurality of light emitting cells. The barrier rib may be formed between adjacent expansion parts. The plurality of electrodes may be formed to be parallel with each other in a single line and crossing the plurality of light emitting cells. The plurality of electrodes may be formed to be indented corresponding to the position of the plurality of light emitting cells.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates an exploded perspective view of a plasma display panel according to the present invention;

FIG. 2 illustrates a plan view of a configuration between light emitting cells and electrodes of the plasma display panel of FIG. 1;

FIG. 3 illustrates a plan view of address electrodes of the plasma display panel of FIG. 1;

FIG. 4 illustrates a plan view of a configuration of the light emitting cells and the address electrodes of the plasma display panel of FIG. 1;

FIGS. 5A to 5C illustrate plan views of a configuration of the light emitting cells and the phosphors of the plasma display panel of FIG. 1; and

FIGS. 6A to 10B illustrate cross-sectional views and layout views of stages in a method of manufacturing a plasma display panel according to an embodiment.

### DETAILED DESCRIPTION

Korean Patent Application No. 10-2008-0101943, filed on Oct. 17, 2008, in the Korean Intellectual Property Office, and entitled: “Plasma Display Panel and Method of Manufacturing the Same” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

The drawings and description are to be regarded as illustrative in nature and not restrictive. In the drawing figures, the dimensions of layers and regions may be exaggerated for clarity of illustration. In addition, when an element is referred to as being “on” another element, it can be directly on the element or be indirectly on the element with one or more intervening elements interposed therebetween. Also, when an element is referred to as being “connected to” another element, it can be directly connected to the element or be indirectly connected to the element with one or more intervening elements interposed therebetween. Similarly, it will also be understood that when a layer is referred to as being “between” two layers, it can be the only layer between the two layers, or one or more intervening layers may also be present. Hereinafter, like reference numerals refer to like elements.

Hereinafter, the exemplary embodiments of the present invention will be described in detail with reference to the accompanying drawings.

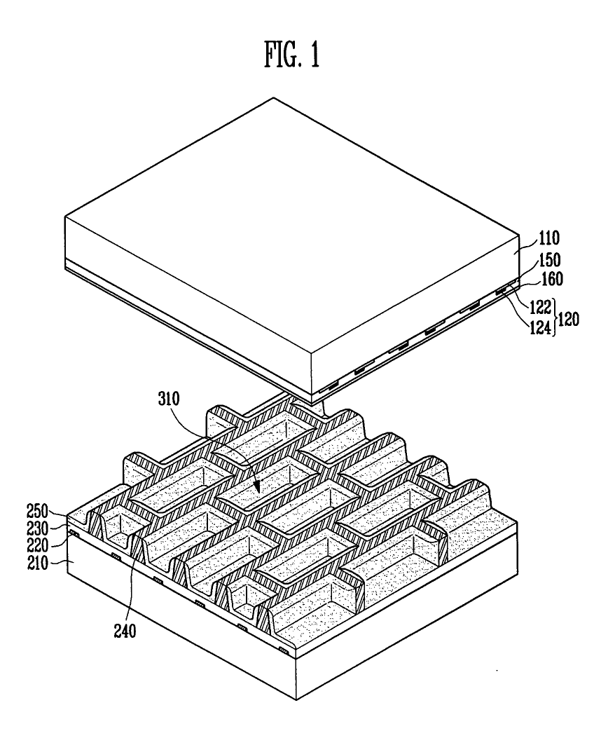

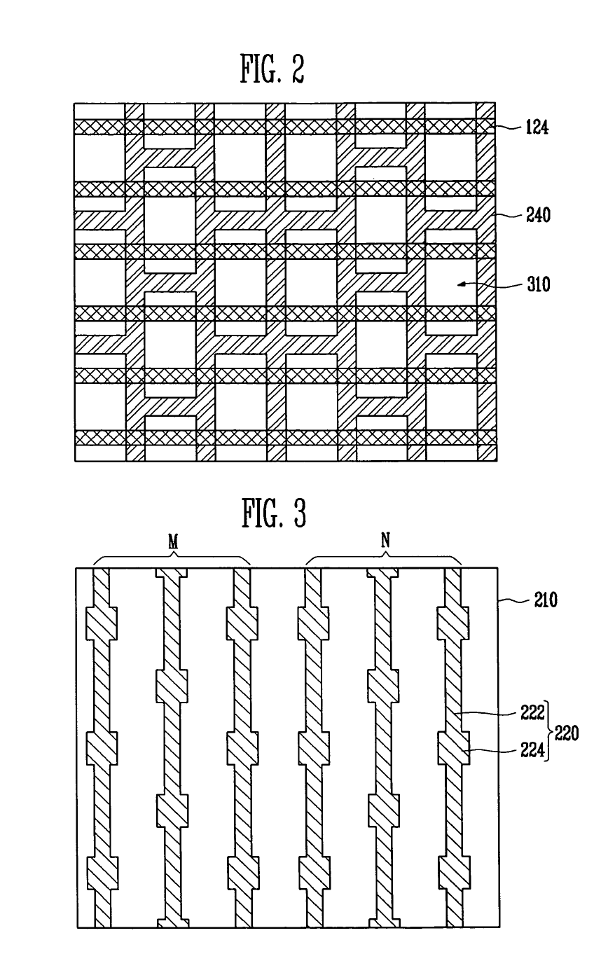

FIG. 1 illustrates an exploded perspective view of a plasma display panel according to an example embodiment. FIG. 2 illustrates a plan view of a configuration between light emitting cells and electrodes of the plasma display panel of FIG. 1.

Referring to FIGS. 1 and 2, the plasma display panel according to example embodiments may include an upper substrate 110, a lower substrate 210, and a plurality of light emitting cells 310, e.g., organic light emitting cells, partitioned between the upper substrate 110 and the lower substrate 210. Phosphor layers 250 may be disposed in the light emitting cells 310, i.e., discharge cells.

The upper substrate 110 may include a plurality of electrodes 120, i.e., display electrodes, thereon. An upper dielectric layer 150 and a passivation film 160 may cover the plurality of electrodes 120.

The plurality of electrodes 120 may be used for forming electric fields to light the light emitting cells 310, and may be disposed on the upper substrate 110 in a direction intersecting address electrodes 220. The plurality of electrodes 120 may be disposed to be parallel with each other with a predetermined interval between adjacent electrodes 120. The plurality of electrodes 120 may be positioned to cross the light emitting cells 310. Each of the plurality of electrodes 120 may include a transparent electrode 122 transmitting visible light generated from the phosphor layer 250, and a bus electrode 124 transferring signals to the transparent electrode 122.

The transparent electrode 122 may allow plasma generated in the light emitting cell 310 to be maintained continuously by a next pulse, and may be formed of a material having a high visible light transmittance. For example, the transparent electrode 122 may be formed of one or more of ITO, SnO₂, ZnO, CdSnO, or the like. The transparent electrode 122 may protrude from the bus electrode 124 into the light emitting cell 310.

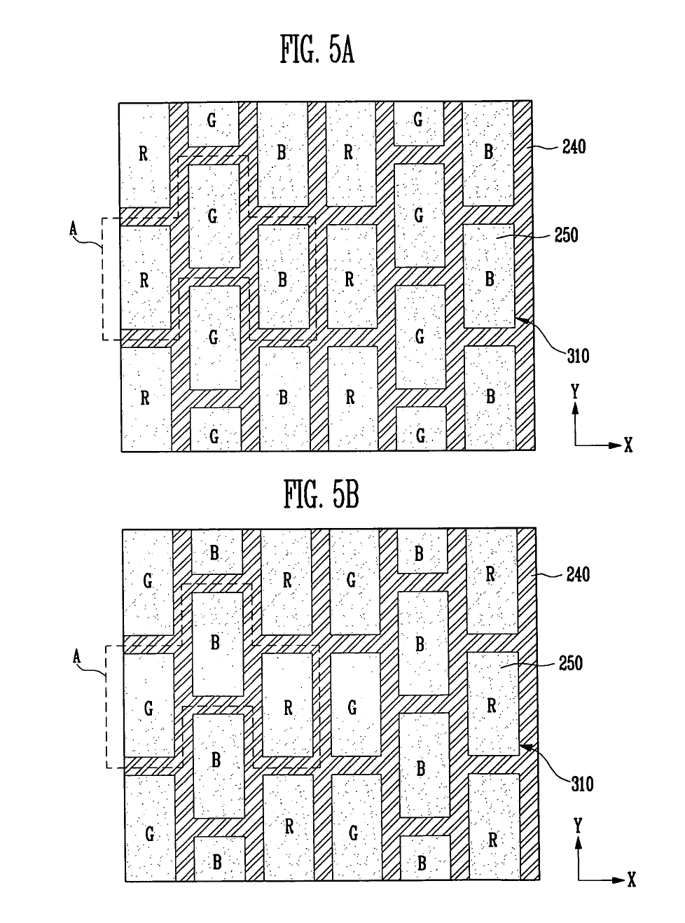

The bus electrode 124 may decrease voltage drop due to resistance at the time of discharge, and may be formed on the transparent electrode 122. The bus electrode 124 may be formed to have a narrow width on a bottom surface of the transparent electrode 122 or may extend into the light emitting cell 310 from one side of the transparent electrode 122. The bus electrode 124 may be formed of a material having low electrical resistance and not reacting with the upper dielectric layer 150. As illustrated in FIG. 2, the bus electrodes 124 of the electrodes 120 may be arranged so a pair of bus electrodes 124 may correspond to each two light emitting cells 310. For example, since the light emitting cells 310 are offset, i.e., as will be discussed in detail with reference to FIG. 4, a same pair of bus electrodes 124 may be oriented to correspond to a same light emitting cell 310 and to two adjacent light emitting cells 310, as illustrated in FIG. 2.

The upper dielectric layer 150 may prevent communication between adjacent electrodes 120, and may prevent the electrodes 120 from being damaged as positive ions or electrons collide with the electrodes 120. Further, the upper dielectric layer 150 may accumulate wall charges by inducing charges. The upper dielectric layer 150 may be on the upper substrate 110 so as to cover the plurality of electrodes 120 sufficiently, i.e., the electrodes 120 may be between the upper substrate 110 and the upper dielectric layer 150. The upper dielectric layer 150 may be formed of a material having high withstand voltage and high visible light transmittance.

The passivation film 160 may prevent the upper dielectric layer 150 from being damaged as positive ions and electrons collide with the upper dielectric layer 150 at the time of discharge, and may lower discharge voltage by emitting a large quantity of secondary electrons at the time of the discharge. The passivation film 160 may be on the dielectric layer 150 to face the light emitting cells 310, and may be formed of a material having high visible light transmittance, high surface insulating properties, and excellent resistance to ion sputtering.

The lower substrate 210 may include a plurality of address electrodes 220 thereon. A lower dielectric layer 230 may cover the plurality of address electrodes 220, and barrier ribs 240 may be positioned on the lower dielectric layer 230 to partition, i.e., define, the plurality of light emitting cells 310 between the lower and upper substrates 110 and 210.

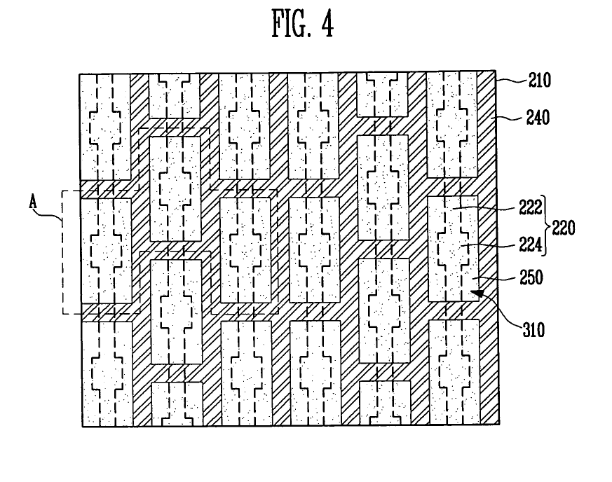

The plurality of address electrodes 220 may generate an address discharge to select light emitting cells 310 to emit light. The address electrodes 220 may be disposed to be parallel with each other on the lower substrate 210 in a direction intersecting with the plurality of the electrodes 120. Each of the plurality of address electrodes 220 may include at least one extension part 222 and at least one expansion part 224 protruding from the extension part 222 toward a barrier rib 240, as shown in FIG. 3. For example, the extension part 222 may be linear, and may extend along a direction intersecting the electrodes 120. The expansion part 224 may protrude from the extension part 222 along a direction parallel to a direction of the electrodes 120, so a width of the expansion part 224 may be larger than a width of the extension part 222 along a direction parallel to a direction of the electrodes 120. For example, as illustrated in FIG. 3, one address electrode 220 may include a plurality of extension and expansion parts 222 and 224 in contact with each other and arranged alternately along a direction intersecting the direction of the electrodes 120. The expansion part 224 may be formed in a circular or polygonal shape. Since the expansion parts 224 of the address electrodes 220 may have increased width, an overlapping area between the electrodes 120 and the expansion parts 224 may be increased, thereby preventing or substantially minimizing a rising phenomenon of discharge voltage or a mis-discharge (or mis-writing) phenomenon at the time of address discharge. Thus, stability of the address discharge may be increased.

An arrangement of the address electrodes 220 will be described in detail.

For ease of description, as illustrated in FIG. 3, the plurality of address electrodes 220 will be referred to as a plurality of groups M and N, while each of the groups M and N may include three adjacent address electrodes 220. The address electrodes 220 in each of the groups M and N may be disposed so that the intervals between the expansion parts 224 in the three address electrodes 220 within each group M and N may be maximized. In other words, the expansion part 224 of at least one address electrode 220 of the three address electrodes 220 in each of the groups M and N may be provided in a row other than a row where the expansion parts 224 of the other two address electrodes 220 of the three address electrodes 220 are provided. For example, each expansion part 224 in an address electrode 220 may be oriented diagonally with respect to an adjacent expansion part 224 of an adjacent address electrode 220 within a same electrode group M or N. For example, the three address electrodes 220 in each group M or N may be arranged so the expansion parts 224 in a middle address electrode 220 of the three address electrodes 220 may be offset along a longitudinal direction of the address electrode 220 with respect to respective expansion parts 224 of each adjacent address electrode 220 of the middle address electrode 220. Two of the three address electrodes 220 in each group M or N, e.g., the two address electrodes 220 on both sides of the middle address electrodes 220 of each of the groups of three address electrodes 220, may have expansion parts 224 aligned with each other in each row. It is noted that a row is oriented along a direction substantially perpendicular to a direction of an address electrode 220.

The groups M and N of address electrodes 220 may be adjacent to each other.

For example, if each of groups M and N includes first through third address electrodes 220, a third address electrode 220 in group M may be adjacent to a first address electrode 220 in group N. The first and third address electrodes 220 in groups N and M may be arranged to have the expansion parts 224 thereof aligned to form rows, e.g., the expansion parts 224 of the third address electrode 220 in group M and first address electrode 220 in group N may be aligned. The second address electrodes 220 in groups M and N, i.e., a second electrode may be between a first electrode and a third electrode, may be arranged to have the expansion parts 224 thereof aligned to form rows that are offset with respect to the rows of expansion parts 224 of the first and third address electrodes 220. Since one address electrode 220 is disposed to alternate with the other two address electrodes 220 in each group M or N, it may be possible to prevent a distance between the address electrodes 220 from narrowing by the expansion part 224. Accordingly, leakage current may be minimized at the time of address discharge, making reduction of power consumption possible.

The address electrode 220 may be formed of a material having high electrical conductivity. For example, the address electrodes 220 may be formed of one or more of Cr, Cu, Ag, Al, and alloy thereof

The lower dielectric layer 230 may prevent the address electrodes 220 from being damaged as positive ions collide with the address electrodes 220 at the time of address discharge. The lower dielectric layer 230 may be formed on the lower substrate 210 so as to cover the address electrodes 220 sufficiently. The lower dielectric layer 230 may be formed of a material having a low reactivity with electrodes and exhibiting insulating properties.

FIG. 4 illustrates a plan view of a configuration of the light emitting cells 310 and the address electrodes 220 in the plasma display panel of FIG. 1.

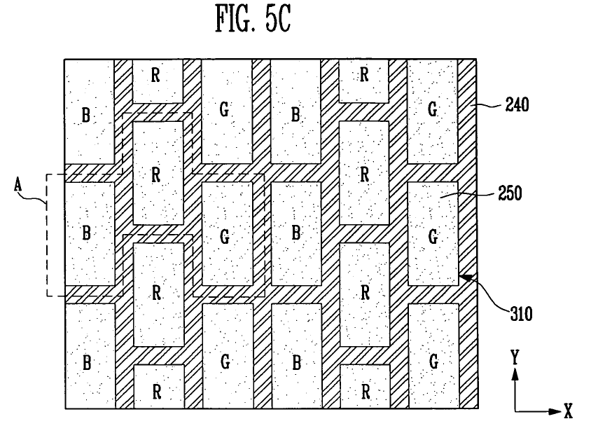

Referring to FIG. 4, the barrier ribs 240 may define the plurality of the light emitting cells 310 by partitioning a region on which the phosphor layer 250 is disposed, and may prevent a cross-talk between adjacent light emitting cells 310. The barrier ribs 240 may be disposed on the lower dielectric layer 230 between expansion parts 224 of the address electrodes 220. For example, as illustrated in FIG. 4, the barrier ribs 240 may be arranged so that each expansion part 240 may correspond to, e.g., center in, a respective emitting cell 310. The barrier ribs 240 may include vertical portions parallel to the address electrodes 220 and horizontal portions substantially perpendicular to the address electrodes 220. For example, the horizontal portions of the barrier ribs 240 may be offset to correspond to the offset expansion parts 224. Accordingly, the light emitting cells 310 defined by the barrier ribs 240 may be arranged in an offset pattern, e.g., a third column of light emitting cells 310 of three adjacent columns of light emitting cells 310 may be offset vertically with respect to the remaining columns of the three adjacent columns of light emitting cells 310. The offset column of the light emitting cells 310 may correspond to an address electrode 220 including the offset expansion parts 224. It is noted that a column is oriented along a direction substantially parallel to a direction of an address electrode 220. A unit pixel A may be defined by three adjacent light emitting cells 310, as discussed in more detail below with reference to FIGS. 5A to 5C.

FIGS. 5A to 5C illustrate plan views of configurations of the light emitting cells 310 and the phosphors 250 in the plasma display panel of FIG. 1.

Referring to FIGS. 5A to 5C, the phosphor layer 250 may include red phosphors R, green phosphors G, and blue phosphors B disposed in each of the plurality of light emitting cells 310 defined by the barrier ribs 240. At least three light emitting cells 310 may be gathered to form one pixel A in order to implement a color image, so that one pixel A may include three light emitting cells 310 coated with red phosphors R; green phosphors G, and blue phosphors B. The light emitting cells 310 may be disposed to alternate according to the arrangement of the plurality of address electrodes 220, so light emitting cells 310 with a same phosphor color may be disposed on a same line in the direction of an x-axis and a y-axis. As illustrated in FIGS. 5A to 5C, for example, each of the green phosphors G, red phosphors R, and blue phosphors B may be arranged in a separate column, e.g., along the y-axis.

For example, as illustrated in FIG. 5A, green phosphor G light emitting cells 310 may be aligned in rows, e.g., a long the x-axis, so light emitting cells 310 with the green phosphors G may be arranged in a separate row, as compared to a row of alternating red phosphors R light emitting cells 310 and blue phosphors B light emitting cells 310. In other words, the light emitting cells 310 with the green phosphors G may correspond to the light emitting cells 310 offset vertically with respect to the remaining light emitting cells 310, i.e., light emitting cells with the red and blue phosphors. In another example, as illustrated in FIG. 5B, blue phosphor B light emitting cells 310 may be aligned in rows, e.g., a long the x-axis, so light emitting cells 310 with the blue phosphors B may be arranged in a separate row, as compared to a row of alternating red phosphors R light emitting cells 310 and green phosphors G light emitting cells 310. In yet another example, as illustrated in FIG. 5C, red phosphor R light emitting cells 310 may be aligned in rows, e.g., a long the x-axis, so light emitting cells 310 with the red phosphors R may be arranged in a separate row, as compared to a row of alternating green phosphors G light emitting cells 310 and blue phosphors B light emitting cells 310.

When the light emitting cells 310 are disposed according to example embodiments, as described with reference to FIGS. 5A-5C, a first light emitting cell 310 of one color in each of the pixels A may be disposed in a row other than a row including light emitting cells 310 with the two remaining colors, and a plurality of the pixels A may be arranged to have the first light emitting cells 310 with the same color disposed in a same row along the x-axis and in a same column along the y-axis. Therefore, viewing efficiency may be improved by preventing color convergence from becoming irregular. In contrast, when conventional light emitting cells are disposed to alternate with each other, e.g., so three colors alternate along a single direction, phosphors of a same color may be arranged along the x-axis in a zigzag pattern, thereby causing irregular color convergence.

The phosphor layer 250 may be preferably formed of material having excellent optical conversion efficiency and excellent color purity. The phosphor layer 250 may be formed on sides of the barrier ribs 240 surrounding the light emitting cells 310 and on an upper surface of the lower dielectric layer 230.

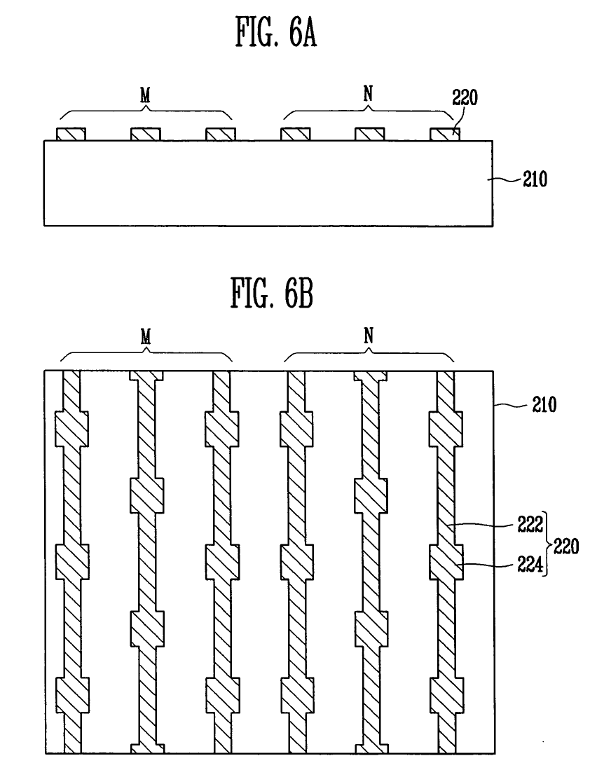

Hereinafter, a method of manufacturing a plasma display panel according to the example embodiments will be described in detail with reference to FIGS. 6A to 10B. FIGS. 6A, 7A, 8A, 9A, and 10A illustrate sectional views, while FIGS. 6B, 7B, 8B, 9B, and 10B illustrate corresponding plan views.

Referring to FIGS. 6A and 6B, the lower substrate 210 may be prepared and a plurality of address electrodes 220 may be formed on the lower substrate 210. The lower substrate 210 may be formed, e.g., by a general manufacturing process of a glass substrate. The address electrode 220 may be formed to have the extension part 222 and the expansion part 224 protruding from the extension part 222 using, e.g., a photolithography method or a photosensitive paste method.

The expansion part 224 may be formed in a circular or polygonal shape. The intersecting area of the address electrode 220 with the electrodes 120 may be increased by the expansion part 224 to prevent a rising phenomenon of discharge voltage or a mis-discharge (or mis-writing) phenomenon at the time of address discharge, such that the address discharge may occur stably.

When the plurality of groups M and N is formed by dividing the plurality of address electrodes 220 into groups including adjacent three address electrodes 220, the address electrodes 220 may be disposed so that intervals between the expansion parts 224 of the address electrodes 220 may be maximized. At this time, the expansion part 224 of at least one address electrode 220 of the three address electrodes 220 in each one of groups M and N may be provided in a row other than a row where the expansion parts 224 of the other two address electrodes 220 are provided. The address electrodes 220 in the plurality of groups M and N may be arranged, so that the expansion parts 224 of the at least one address electrode 220 may be aligned with corresponding address electrodes 220 in all the groups M and N to define a single line, e.g., along the x-axis, and the other two address electrodes. 220 in all the groups may be aligned to define a single line in a different row. One address electrode 220 may be disposed to alternate with the other two address electrodes 220 in one group M or N, making it possible to prevent the distance between the address electrodes 220 from narrowing by the expansion part 224. Thereby, leakage current may be minimized at the time of address discharge, making it possible to reduce power consumption.

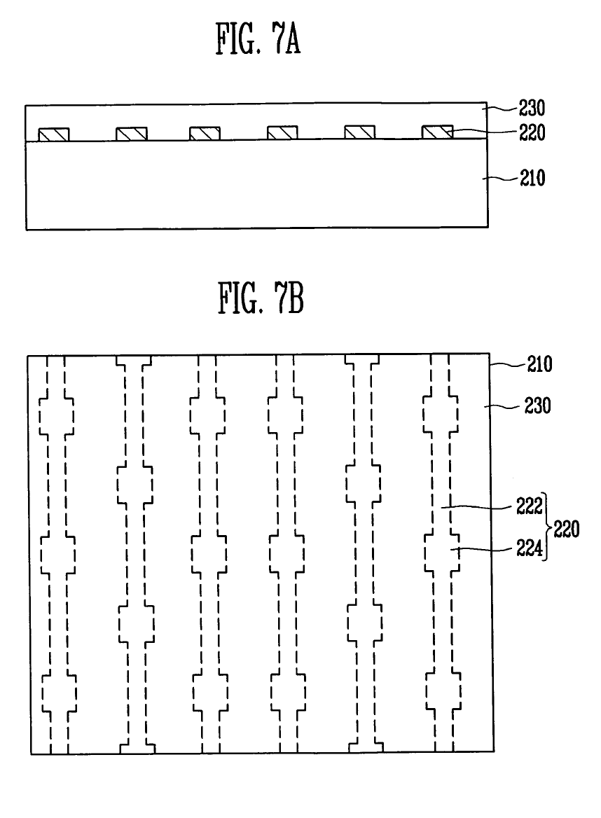

Referring to FIGS. 7A and 7B, the lower dielectric layer 230 for protecting address electrodes 220 may be formed on the address electrodes 220 and over the lower substrate 210 including the address electrodes 220. The lower dielectric layer 230 may be formed, e.g., using a screen printing method or a dry film method.

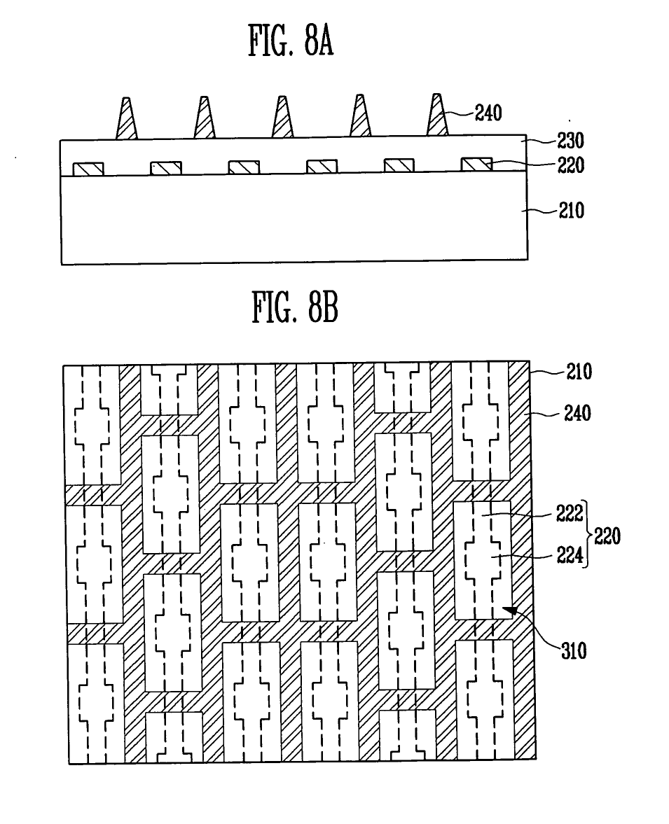

Referring to FIGS. 8A and 8B, the barrier ribs 240 may be formed so as to partition the plurality of light emitting cells 310. The barrier ribs 240 may be formed on the lower dielectric layer 230 between expansion parts 224 the plurality of address electrodes 220, so that the expansion parts 224 may be provided in the light emitting cells 310 corresponding to the arrangement of the plurality of address electrodes 220. The barrier ribs 240 may be formed using, e.g., a screen printing method, a sandblasting method, a squeezing method, a photography method, and a direct etching method.

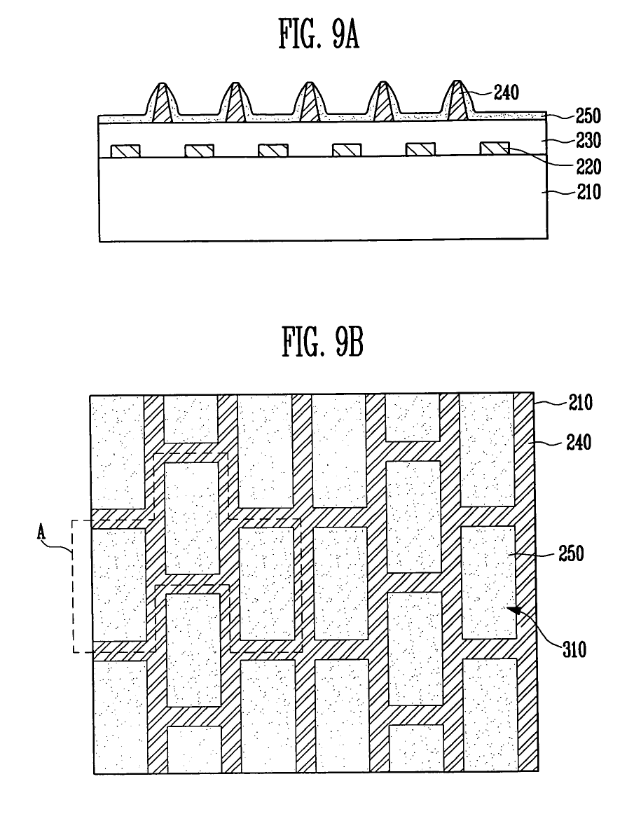

Referring to FIGS. 9A and 9B, the phosphor layer 250 may be formed in the plurality of light emitting cells 310 between the barrier ribs 240. In each of the light emitting cells 310 defined by the barrier ribs 240, the phosphor layer 250 may include red phosphors, green phosphors, and blue phosphors. The phosphor layer 250 may be formed on sides of the barrier ribs 240 surrounding the light emitting cells 310 and on the upper surface of the lower dielectric layer 230.

At least three light emitting cells 310 may be gathered to define one pixel A in order to implement a color image, so that one pixel A may include three light emitting cells 310 coated with red phosphors, green phosphors, and blue phosphors. In one pixel A, at least one light emitting cell 310 may be formed in a row other than a row the other light emitting cells 310 are formed. At this time, the light emitting cells 310 coated with phosphors having the same color in a plurality of pixels may be formed in a single line in a row or in a column.

When conventional light emitting cells are disposed to alternate with each other, the phosphors of the same color may be arranged on the x-axis in zigzags so that color convergence may become irregular. However, according to example embodiments, one specific light emitting cell 310 may be disposed in a row other than a row where the other two light emitting cells 310 are disposed in each of the pixels A, and the specific light emitting cells 310 included in the respective pixels A are disposed in a single line in the same row. Therefore, the address power may be reduced by preventing the distance between the address electrodes 220 from narrowing, and the viewing efficiency may be improved by preventing color convergence from being irregular.

The phosphor layer 250 may be formed through, e.g., a printing method using phosphor paste, a forming method using photosensitive phosphor paste, a forming method using a dry film or the like.

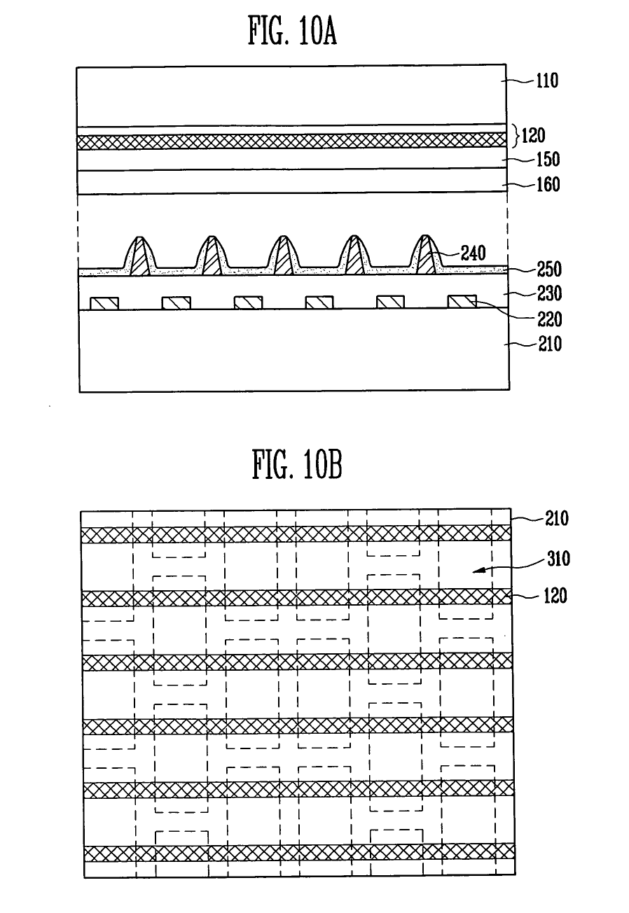

Referring to FIGS. 10A and 10B, the plurality of electrodes 120 may be formed on the upper substrate 110. The plurality of electrodes 120 may be formed to be parallel with each other, crossing the plurality of light emitting cells 310, with predetermined intervals between the neighboring ones in a direction intersecting with the plurality of address electrodes 220.

The upper dielectric layer 150 may be formed on the bottom surface of the upper substrate 110 including the plurality of electrodes 120, and then the passivation film 160 protecting the upper dielectric layer 150 may be formed, thereby completing the preparation of the upper substrate 110.

After the upper substrate 110 and the lower substrate 210 manufactured in the method described above are sealed so that gas inlets are formed, discharge gas may be injected through the gas inlets. The gas inlets may be sealed, thereby manufacturing a plasma display panel.

Meanwhile, in the embodiment and drawings as above, the plurality of electrodes 120 is described as disposed in a single line in a same row. However, the present invention is not limited thereto. In other words, the plurality of electrodes 120 may be disposed to be indented corresponding to the disposition of the plurality of light emitting cells 310 or may be disposed in any other suitable configuration.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel, comprising:
an upper substrate and a lower substrate disposed to be opposite to each other;
a plurality of address electrodes extending along a first direction on the lower substrate;
a plurality of electrodes extending along a second direction on the upper substrate, the second direction intersecting the first direction;
a plurality of light emitting cells partitioned by barrier ribs between the upper substrate and the lower substrate, the light emitting cells including first light emitting cells aligned in a first row along the second direction and second light emitting cells aligned in a second row along the second direction, the first row being offset along the first direction with respect to the second row; and
phosphor layers in the light emitting cells, all the first light emitting cells in the first row having phosphor layers of a same color.

2. The plasma display panel as claimed in claim 1, wherein light emitting cells with phosphor layers having the same color are disposed in a same column along the first direction.

3. The plasma display panel as claimed in claim 1, wherein three light emitting cells including respective red, green, and blue phosphor layers define a pixel, one of the three light emitting cells being a first light emitting cell in the first row and the remaining two light emitting cells being second light emitting cells in the second row.

4. The plasma display panel as claimed in claim 1, wherein the second light emitting cells in the second row have phosphor layers of two colors arranged in an alternating pattern, the two colors of the phosphor layers in the second row being different than the phosphor layer color in the first row.

5. The plasma display panel as claimed in claim 1, wherein the first light emitting cells in the first row are spaced apart from each other by a constant predetermined interval, the first and second rows overlapping each other along the first direction.

6. The plasma display panel as claimed in claim 1, wherein each of the plurality of address electrodes includes at least one extension part and at least one expansion part, the expansion part being wider than the extension part along the second direction.

7. The plasma display panel as claimed in claim 6, wherein the expansion part is circular or polygonal, the extension part being centered with respect to the expansion part.

8. The plasma display panel as claimed in claim 6, wherein the address electrodes are arranged to correspond to the light emitting cells, the address electrodes including first address electrodes offset along the first direction with respect to second address electrodes, the expansion parts of the first and second address electrodes being in different rows along the second direction.

9. The plasma display panel as claimed in claim 6, wherein the expansion part is positioned inside each of the plurality of light emitting cells.

10. The plasma display panel as claimed in claim 6, wherein the barrier rib is between adjacent expansion parts.

11. The plasma display panel as claimed in claim 1, wherein electrodes of the plurality of electrodes are parallel with each other in a single line and cross the plurality of light emitting cells in a direction intersecting the plurality of address electrodes.

12. A method of manufacturing a plasma display panel, comprising:
forming an upper substrate and a lower substrate disposed to be opposite to each other;
forming a plurality of address electrodes extending along a first direction on the lower substrate;
forming a plurality of electrodes extending along a second direction on the upper substrate, the second direction intersecting the first direction;
forming a plurality of light emitting cells partitioned by barrier ribs between the upper substrate and the lower substrate, the light emitting cells including first light emitting cells aligned in a first row along the second direction and second light emitting cells aligned in a second row along the second direction, the first row being offset along the first direction with respect to the second row; and
forming phosphor layers in the light emitting cells, all the first light emitting cells in the first row having phosphor layers of a same color.

13. The method as claimed in claim 12, further comprising:
forming dielectric substances throughout the lower substrate including the plurality of address electrodes; and
forming a plurality of pixels by coating the plurality of light emitting cells with red phosphors, green phosphors, and blue phosphors,
the first light emitting cell in each of the plurality of pixels being disposed in the first row and the other two light emitting cells in each pixel being disposed in the second row.

14. The method as claimed in claim 12, wherein each of the plurality of address electrodes includes at least one extension part and at least one expansion part, the expansion part being wider than the extension part along the second direction.

15. The method as claimed in claim 14; wherein the expansion part is circular or polygonal, the extension part being centered with respect to the expansion part.

16. The method as claimed in claim 14, wherein the expansion part is positioned inside each of the plurality of light emitting cells.

17. The method as claimed in claim 14, wherein the barrier rib is formed between adjacent expansion parts.

18. The method as claimed in claim 12, wherein the plurality of electrodes are formed to be indented corresponding to the position of the plurality of light emitting cells.
